(19) United States
(12) Patent Application Publication
(10) Pub. No.: US 2026/0337800 A1
(43) Pub. Date: Oct. 29, 2026

(54) MEMBRANE FOR ALKALINE WATER ELECTROLYSIS

(71) Applicant: SOLVAY SPECIALTY POLYMERS USA, LLC, Alpharetta, GA (US)

(72) Inventors: Dario Aurilia, Cerro Maggiore (MI) (IT); Emanuele Di Nicolo', Gorla Minore (VA) (IT); Kelly Branham, Woodstock, GA (US)

(73) Assignee: SYENSQO SPECIALTY POLYMERS USA, LLC, Alpharetta, GA (US)

(21) Appl. No.: 19/117,333

(22) PCT Filed: Sep. 18, 2023
(86) PCT No.: PCT/EP2023/075635

§ 371 Date: Mar. 31, 2025

Related U.S. Application Data
(60) Provisional application No. 63/411,209, filed on Sep. 29, 2022.

(30) Foreign Application Priority Data
Nov. 24, 2022 (EP) 22209371.8

(51) Int. Cl. C25B 13/08; C25B 1/04

(52) U.S. Cl. CPC C25B 13/08; C25B 1/04

(57) ABSTRACT

A membrane adapted for alkaline water electrolysis is disclosed together with an alkaline water electrolysis device containing the membrane. A method for producing hydrogen, and a method for producing a membrane for alkaline water electrolysis are also disclosed.

### REFERENCE TO RELATED APPLICATIONS

This application claims priority from U.S. provisional patent application No. 63/411,209 filed on 29 Sep. 2022 and from EP patent application number 22209371.8 filed on 24 Nov. 2022, the whole content of each of these applications being incorporated herein by reference for all purposes.

### TECHNICAL FIELD

The invention relates to a membrane suitable for alkaline water electrolysis, an alkaline water electrolysis device, a method for producing hydrogen, and a method for producing a membrane for alkaline water electrolysis.

### BACKGROUND ART

Hydrogen has been used in a wide variety of industrial applications such as in petroleum refining, chemical synthesis materials, metal refining, and stationary fuel cells. Nowadays, the use of hydrogen is expected to grow in hydrogen stations for fuel cell vehicles (FCV), smart communities, and hydrogen power plants. In view of this, attention is being focused on techniques for producing high-purity hydrogen.

One industrial method for producing hydrogen is the water electrolysis process. This process has the advantage that it can be coupled with means for the generation of energy using renewable resources, such as wind and solar, which require to maintain the balance between supply and demand in power grids.

In a typical water electrolysis process, an aqueous solution containing an electrolyte, such as sodium hydroxide or potassium hydroxide, is used as an electrolyte solution to obtain increased electrical conductivity. Applying direct-current electricity to this electrolyte solution by means of a cathode and an anode induces water electrolysis process.

An electrolytic cell used for electrolysis process (which hereinafter may be simply referred to as “electrolysis”) is divided by a membrane into an anode compartment and a cathode compartment. In the anode compartment there is produced oxygen gas, while in the cathode compartment there is produced hydrogen gas. The membrane is required to have gas impermeability, to prevent mixing of the oxygen gas and hydrogen gas, and at the same time high ion permeability to allow ions to flow within the cell generating electricity. Accordingly, membranes having a porous structure and high ion permeability are required.

WO 93/15529A1 discloses a diaphragm for alkaline water electrolysis that is a porous membrane formed by incorporating zirconium oxide or magnesium oxide into polysulfone which is an aromatic polymer resin and carrying out a non-solvent-induced phase separation process. It has been observed that the inorganic particles tend to detach from the pores as the electrolysis is continued, with the result that the number of the inorganic particles on the surfaces of the porous membrane decreases. In the long term this reduces the performance of the membrane by allowing gas bubbles to attach to the surfaces of the porous membrane and hinder the permeation of ions.

The existing technical solutions still leave room for improvement. For example, when a diaphragm in the form of a porous membrane is sandwiched between electrodes (an anode and a cathode), hydrogen and oxygen evolved from the electrodes attach in the form of gas bubbles to the surfaces of the porous membrane and close the pores in the surfaces of the porous membrane. This causes an increase in voltage loss due to the diaphragm during electrolysis, since ions cannot permeate through the pores closed with gas bubbles. This problem of voltage loss increase is considerably significant if the surfaces of the porous membrane are hydrophobic, because in this case gas bubbles readily attach to the surfaces.

Hence the need still exist to provide a membrane for alkaline water electrolysis that is free from deterioration of ion permeability caused by bubble attachment and that does not suffer from the deterioration of properties caused by the loss of hydrophilic inorganic particles.

### SUMMARY OF INVENTION

The Applicant faced with the problem of providing membranes which do not suffer from the drawbacks described above and which can be manufactured in the form of flat sheet and which are suitable for use in alkaline electrolysis found that the above mentioned problems can be solved by a membrane comprising at least one poly(aryl ether ketone) polymer said membrane endowed with a contact angle measured according to the captive bubble contact angle test of at least 155° and/or characterised by a static contact angle that decreases over time. The membrane is a porous membrane. The membrane comprises at least one surface comprising a functionalized poly(aryl ether ketone) polymer having hydroxyl groups bound to the aromatic rings of the poly(aryl ether ketone) chain.

Poly(aryl ether ketone)s represent a class of semi-crystalline engineering thermal plastics with outstanding thermal properties and chemical resistance. Poly(aryl ether ketone) polymers are virtually insoluble in all common solvents at room temperature. These properties make poly(aryl ether ketone) attractive materials for porous membrane preparation.

### DESCRIPTION OF INVENTION

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the invention is a membrane as defined in the appended claims. The membrane has a contact angle measured according to the captive bubble contact angle test of at least 155°.

The captive air bubble (CAB) contact angle test provides a measure of the hydrophilicity of the membrane. It may be measured by a contact angle goniometer as described in full detail in the Experimental Section. High hydrophilicity is associated with a high contact angle. In the present specification a fully wettable surface has a contact angle according to captive bubble contact angle test of 180°.

Without being bound by theory it is believed that an increased hydrophilicity of the membrane, in particular of the surface of the membrane, may reduce the tendency of gases, like hydrogen and oxygen, to attach to the surface of the membrane thus closing the pores of the membrane, hindering the passage of ions during electrolysis.

The membrane of the invention is characterised by a contact angle measured according to captive air bubble contact angle test of at least 155°, even at least 157°. The captive air bubble contact angle test comprises immersing the membrane in deionized water at room temperature, dropping a 2 pL air bubble at the surface of the membrane using a J-shaped syringe, measuring the contact angle between the air bubble and the surface of the membrane using an optical tensiometer equipped with a high quality monochromatic cold LED light and a high resolution digital camera. The air bubble is dropped at the surface of the membrane comprising the functionalized poly(aryl ether ketone) polymer.

The inventive membrane is alternatively or additionally characterised by a static contact angle that decreases over time. The static contact angle is measured according to ASTM D 5725-99.

The membrane of the invention is characterised by a static contact angle which when measured after 60 seconds is at least 15° lower than the initial value. In certain advantageous embodiments, the static contact angle is at least 10° lower after 10 seconds, even 20° lower after 10 seconds. The expression “initial value” means the value of the static contact angle determined at the initial time when the water droplet is placed on the surface of the membrane.

The determination of the variation of the static contact angle over time is performed by measuring the static contact angle according to ASTM D 5725-99 at an initial time, waiting an interval of time and performing a new measurement of the contact angle on the same sample under the same experimental conditions.

The captive air bubble contact angle and the static contact angle are conveniently measured on the at least one surface comprising the functionalized poly(aryl ether ketone) polymer.

The membrane comprises at least one poly(aryl ether ketone) polymer.

The expression “poly(aryl ether ketone) polymer” is used herein to refer to any polymer comprising at least 50 mol % of recurring units (R_{PAEK}) having a Ar—C(═O)—Ar′ group, wherein Ar and Ar′, equal to or different from each other, are aromatic groups, preferably phenyl groups.

The poly(aryl ether ketone) polymer has at least 60 mol %, at least 80 mol %, at least 90 mol %, at least 95 mol % or at least 98 mol % of recurring units (R_{PAEK}). Recurring units (R_{PAEK}) are selected from the group consisting of formulae (J-A) to (J-O), herein below:

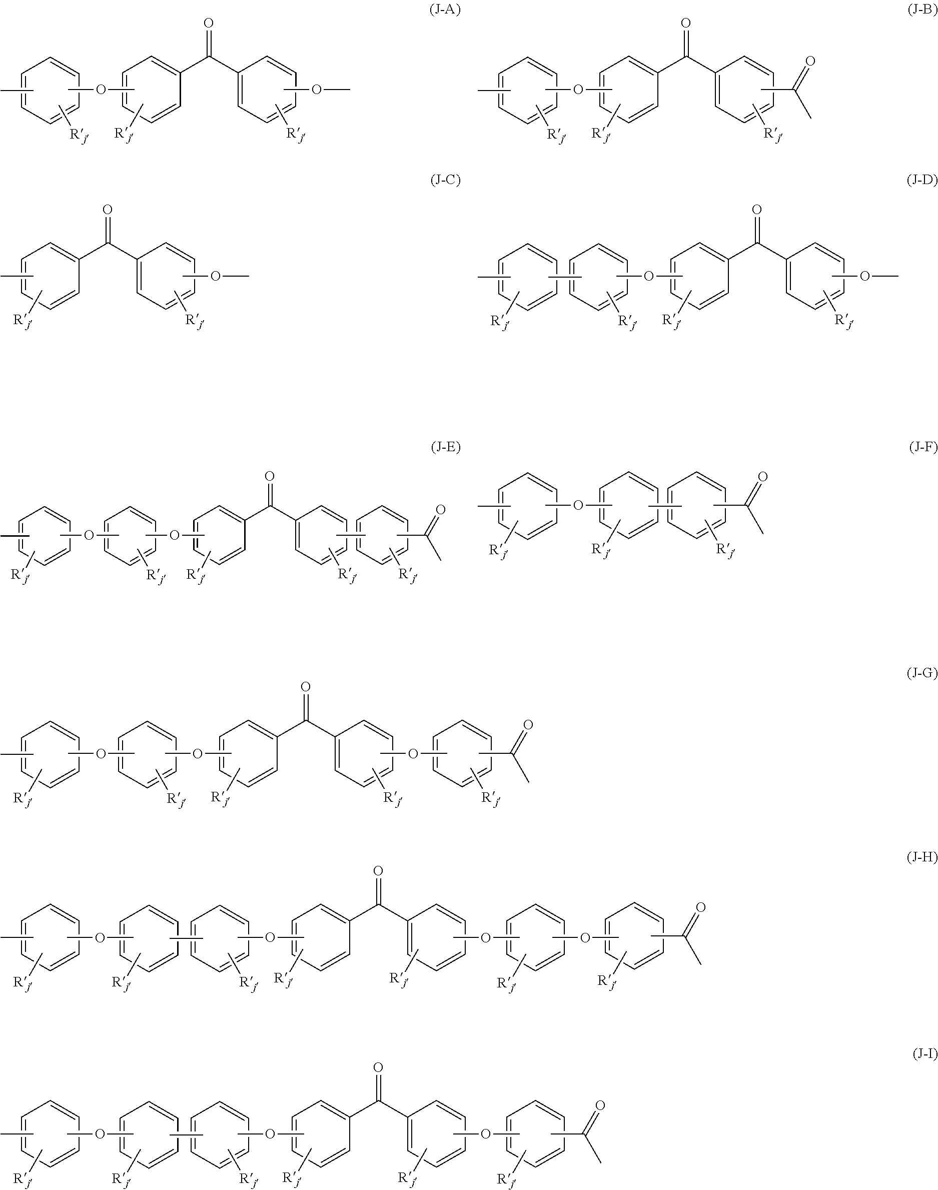

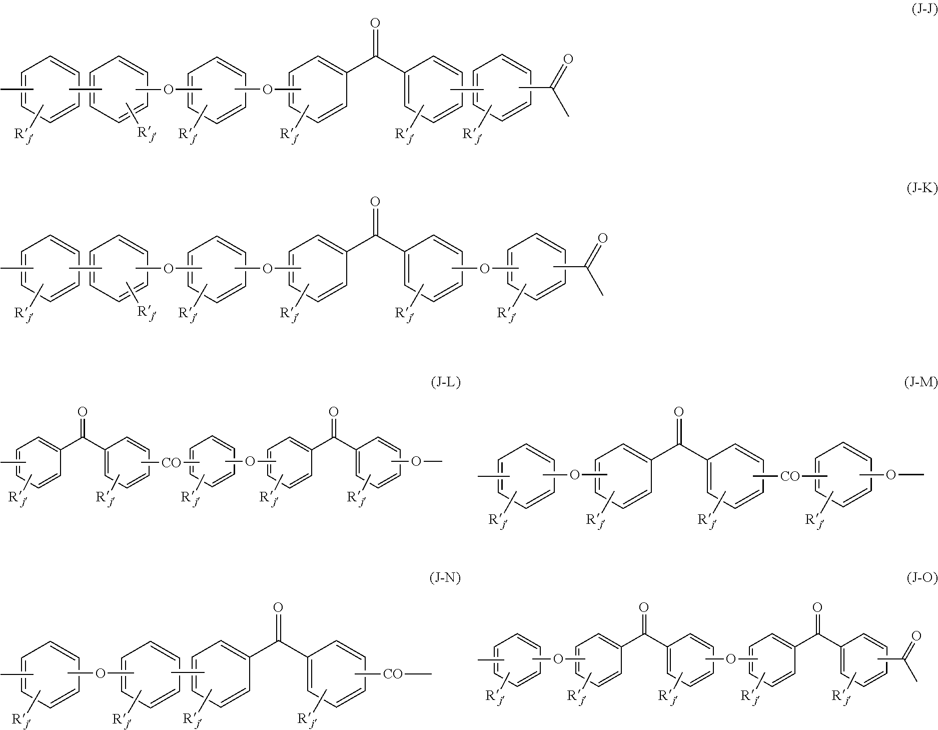

where:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 1 to 4.

The respective phenylene moieties of recurring unit (R_{PAEK}) can independently have 1,2-, 1,4- or 1,3-linkages to the other moieties different from R′ in the recurring unit. The phenylene moieties may have 1,3- or 1,4-linkages. Typically, the phenylene moieties have 1,4-linkages.

Furthermore, in some embodiments, j′ in recurring units (R_{PAEK}) are at each occurrence zero; that is to say that the phenylene moieties have no other substituents than those enabling linkage in the main chain of the polymer. In some such embodiments, recurring units (R_{PAEK}) can be represented by a formula selected from the group of formulae (J′-A) to (J′-O) below:

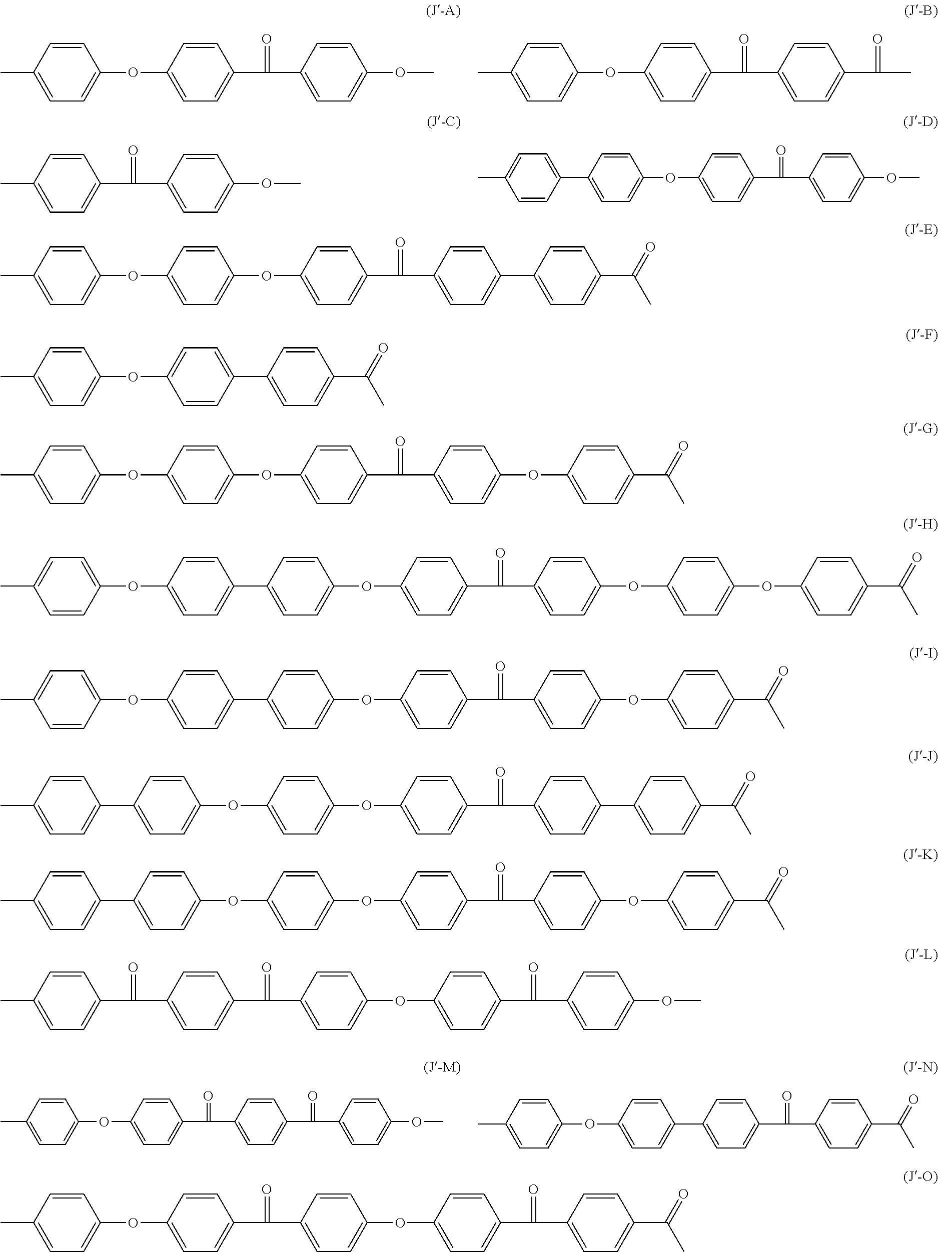

The poly(aryl ether ketone) polymer may be a homopolymer, a random, an alternate or a block copolymer. When the poly(aryl ether ketone) polymer is a copolymer, it may contain (i) recurring units (R_{PAEK}) of at least two different formulae chosen from formulae (J-A) to (J-O) or (J′-A) to (J′-O), or (ii) recurring units (R_{PAEK}) of one or more formulae (J-A) to (J-O) or (J′-A) to (J′-O) and recurring units (R*_{PAEK}) different from recurring units (R_{PAEK}).

Recurring units (R_{PAEK}) are conveniently selected from the group consisting of units of formulae (J′-A) to (J′-D) and (J″-B):

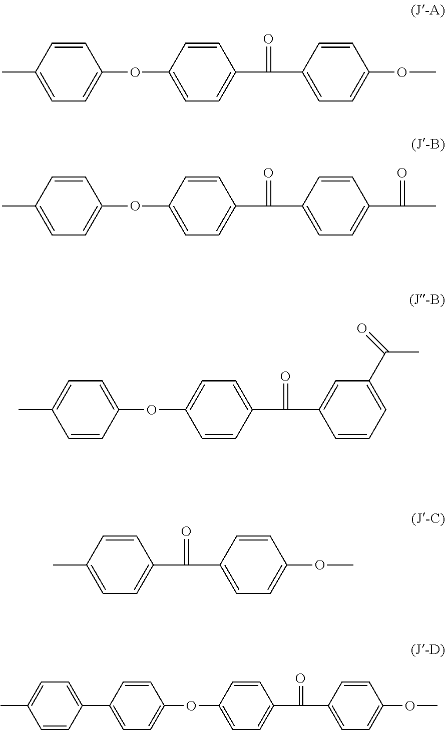

The membrane comprises at least one surface comprising a functionalized poly(aryl ether ketone) polymer. In the remainder of the text the expression “functionalized poly(aryl ether ketone) polymer” is used to refer to a poly(aryl ether ketone) polymer which comprises hydroxyl groups bound to aromatic rings of a poly(aryl ether ketone) polymer backbone. Preferably, the hydroxyl groups are directly bound to carbon atoms of the aromatic rings.

The functionalized poly(aryl ether ketone) polymer comprises recurring units (R_{PAEK-OH}) which are selected from the group consisting of units of formulae (K-A) to (K-D) below:

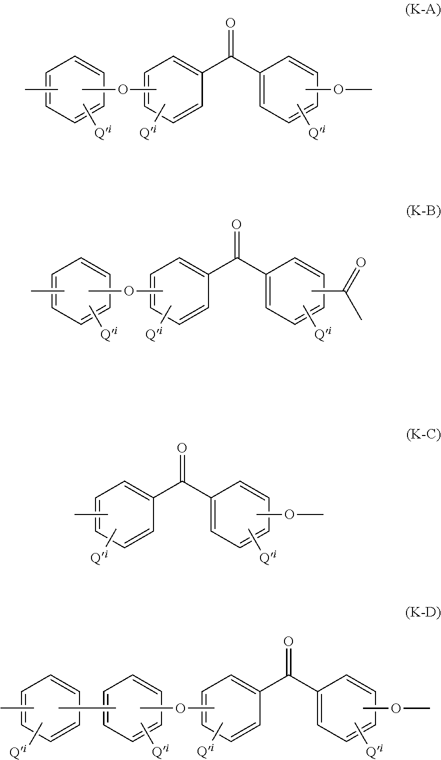

in which each of Q′ is —OH and, independently at each instance, i is zero or an integer from 1 to 4, with the proviso that in a given recurring unit the total sum of all i is different from zero.

The functionalized poly(aryl ether ketone) polymer may additionally comprise recurring units (R_{PAEK}) which are selected from the group consisting of units of formulae (J′-A) to (J′-D) and (J″-B) as defined above.

In recurring units (R_{PAEK-OH}) the phenylene moieties may independently have 1,2-, 1,4- or 1,3-linkage to the other moieties different from Q′ in the recurring unit (R_{PAEK-OH}).

The functionalized poly(aryl ether ketone) polymer includes a combined amount of recurring unit (R_{PAEK-OH}) and recurring unit (R_{PAEK}) of at least 50 mol %, relative to the total number of recurring units in the functionalized poly(aryl ether ketone) polymer. The functionalized poly(aryl ether ketone) polymer typically comprises a combined amount of recurring units (R_{PAEK-OH}) and recurring units (R_{PAEK}) of at least 60 mol %, at least 65 mol %, at least 70 mol %, at least 75 mol %, at least 80 mol %, at least 85 mol %, at least 90 mol %, at least 95 mol %, or at least 99.9 mol %, relative to the number of recurring units in the functionalized poly(aryl ether ketone) polymer.

In some instances, the functionalized poly(aryl ether ketone) polymer may comprise 0.001 mol % or more, even 0.005 mol % or more, in some instances 0.01 mol % or more, of recurring units (R_{PAEK-OH}) relative to the number of recurring units in the functionalized poly(aryl ether ketone) polymer.

Advantageously, the functionalized poly(aryl ether ketone) polymer is selected from the group comprising, preferably consisting of, functionalized poly(ether ether ketone) (f-PEEK) and a functionalized copolymer of PEEK and poly(diphenyl ether ketone) (f-PEEK-PEDEK copolymer) as well as their blends.

The expression “functionalized poly(ether ether ketone) (f-PEEK) denotes any polymer comprising recurring units of formula (K-A) and (J′-A) above. Preferably, the phenylene moieties in recurring units (K-A) and (J′-A) have a 1,4-linkage.

Preferably at least 60 mol %, 70 mol %, 80 mol %, 90 mol %, 95 mol %, 99 mol %, and most preferably all of recurring units are a combination of recurring units (K-A) and (J′-A). The amount of recurring units (K-A) is different from zero.

The expression functionalized copolymer of PEEK and poly(diphenyl ether ketone), f-PEEK-PEDEK copolymer, denotes any polymer comprising recurring units of formula (K-A) and/or (J′-A) (PEEK recurring unit) and recurring units of formula (K-D) and/or (J′-D) (poly(diphenyl ether ketone) (PEDEK) recurring unit):

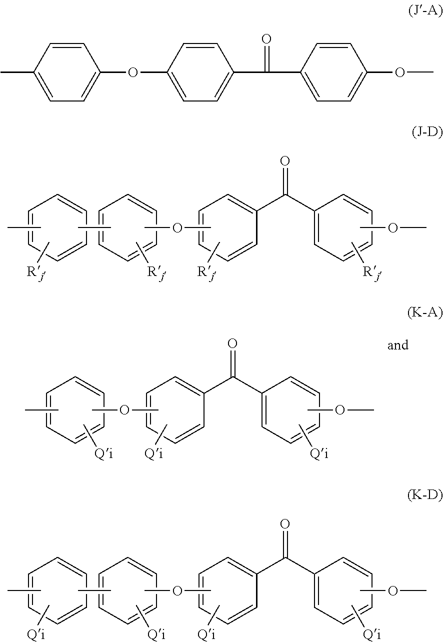

wherein R′, j′, Q′ and i are as defined above. Preferably, the phenylene moieties in recurring units (K-A), (J′-A), (K-D) and (J′-D) have a 1,4-linkage.

The f-PEEK-PEDEK copolymer may include relative molar proportions of PEEK recurring units and PEDEK recurring units ranging from 95/5 to 60/40. Preferably the sum of recurring units (K-A), (J′-A), (K-D) and (J′-D) represents at least 60 mol %, 70 mol %, 80 mol %, 90 mol %, 95 mol %, 99 mol %, of recurring units in the functionalized poly(aryl ether ketone) polymer, with the proviso that the amount of recurring units (K-A)+(K-D) is different from zero.

Most preferably, the functionalized poly(aryl ether ketone) polymer is f-PEEK or f-PEEK-PEDEK or a blend of f-PEEK and f-PEEK-PEDEK as defined above.

The membrane of the invention comprises at least one surface comprising at least one functionalized poly(aryl ether ketone) polymer which comprises hydroxyl groups bound to aromatic rings of the poly(aryl ether ketone) polymer backbone. The remainder of the membrane may comprise a poly(aryl ether ketone) polymer having the same backbone of the functionalized poly(aryl ether ketone) polymer or a different backbone.

The membrane of the invention may have both surfaces comprising at least one functionalized poly(aryl ether ketone) polymer as defined above.

The membrane of the invention may have the same composition throughout its thickness, said composition comprising at least one functionalized poly(aryl ether ketone) polymer as defined above.

The term “membrane” is intended to indicate to a discrete, generally thin, interface that moderates the permeation of chemical species in contact with it, said membrane containing pores of finite dimensions. The membrane of the invention is a porous membrane.

Membranes containing pores homogeneously distributed throughout their thickness are generally known as symmetric (or isotropic) membranes.

Membranes containing pores which are heterogeneously distributed throughout their thickness are generally known as asymmetric (or anisotropic) membranes.

The inventive membrane may be either a symmetric membrane or an asymmetric membrane. Asymmetric membranes may include a thin selective layer (0.1-1.0 μm thick) and a highly porous thick layer (100-200 μm thick) which acts as a support and has little effect on the separation characteristics of the membrane.

The membrane of the invention has an average pore diameter from 50 nm to 200 nm, typically from 60 to 150 nm.

The membrane has a bubble point (i.e. the measure of the largest pore) from 100 nm to 400 nm, typically from 150 nm to 300 nm. The membrane has a smallest pore diameter from 40 nm to 120 nm, typically from 50 to 100 nm.

Pore diameters and bubble point can be measured according to ASTM F316.

Suitable techniques for the determination of the average pore diameter in the porous membranes of the invention are described for instance in Handbook of Industrial Membrane Technology. Edited by PORTER, Mark C. Noyes Publications, 1990. p.70-78. Pore size of the membrane may be estimated by several techniques including Scanning Electron Microscopy (SEM), and/or measurements of bubble point, gas flux, water flux, and molecular weight cut off.

The membrane of the invention may be either a self-standing porous membrane, consisting of one porous layer, or a multi-layered membrane, preferably comprising at least one porous layer supported onto a substrate. The substrate is preferably made of material(s) having a minimal influence on the selectivity of the porous membrane.

The membrane of the invention preferably has a structure in which a porous polymer membrane encloses a porous substrate, and more preferably has a structure in which porous polymer membranes are laminated on both surfaces of a porous substrate. Inclusion of a substrate may enhance the strength of the membrane. For example, defects such as cuts and tears in, and stretching of, the membrane due to mechanical stresses can be prevented.

The material of the substrate is preferably, but not limited to, a material that causes no substantial reduction in the permeability of the membrane to ions of an electrolyte solution. Examples of the material of the porous substrate include, but are not limited to, poly(phenylene sulfide), polyethylene, polypropylene, poly(vinylidene fluoride), polytetrafluoroethylene, polyparaphenylene benzobisoxazole, poly(ether ketone), polyimide, and polyetherimide. Among these, polyphenylene sulfide is preferably contained. The use of poly(phenylene sulfide) allows the porous substrate to exhibit high resistance to high-temperature, high-concentration alkaline solutions and exhibit high chemical stability against active oxygen evolved from an anode during water electrolysis process. In addition, with the use of poly(phenylene sulfide), the porous substrate can easily be processed into various forms such as a woven fabric and a non-woven fabric, and can thus be appropriately modified according to the intended application or intended use environment. The above-mentioned materials may be used alone or in combination of two or more thereof.

Examples of the porous substrate include, but are not limited to, a mesh, a porous membrane, a non-woven fabric, a woven fabric. These may be used alone or in combination of two or more thereof. Examples of more preferred forms of the porous substrate include a mesh substrate made up of monofilaments of poly(phenylene sulfide) and a composite fabric including a non-woven fabric and a woven fabric enclosed in the non-woven fabric.

Depending on its final intended use, the inventive membrane can be flat or tubular in shape.

Flat membranes are generally preferred for use in electrolysis cells.

The scope of the invention is nevertheless not limited to flat membranes but also encompasses tubular and hollow fiber membranes. These are particularly advantageous in applications wherein compact modules having high surface areas are required.

When the membrane is flat, its thickness is advantageously from 10 to 800 microns, even from 25 to 600 microns, preferably from 200 to 500 microns.

When the membrane is tubular, its outer diameter can be up to 15.0 mm.

When the membrane has an outer diameter comprised between 0.5 mm and 3.0 mm, it is referred to as hollow fibers membrane. When the membrane has a diameter of less than 0.5 mm, it is referred to as capillary membrane.

In certain embodiments the membrane may comprise a composition comprising at least one poly(aryl ether ketone) polymer and/or at least one functionalized poly(aryl ether ketone) polymer and a radical scavenger.

The radical scavenger is preferably selected from the group of inorganic scavengers, in particular from the group consisting of the cerium salts and oxides.

### Method for Making the Membrane

The membrane of the invention may be prepared from a poly(aryl ether ketone) polymer as defined above.

In certain embodiments it can be prepared starting from a functionalized poly(aryl ether ketone) polymer as defined above, that is a poly(aryl ether ketone) polymer comprising hydroxyl groups bound to aromatic rings of the poly(aryl ether ketone) polymer backbone.

In said embodiments, the functionalized poly(aryl ether ketone) polymer can provide only one surface layer of the membrane, both surface layers or it can be used to manufacture the whole membrane. The functionalized poly(aryl ether ketone) polymer can be used alone or in composition with another polymer, typically a polymer selected in the group of the poly(aryl ether ketone) polymers as detailed above.

Alternatively, in a preferred embodiment, the membrane is obtained by chemically treating a membrane comprising a poly(aryl ether ketone) polymer and having a contact angle measured according to the captive bubble contact angle test of less than 155° and/or a static contact angle that does not decrease over time, hereinafter the “Precursor Membrane”.

The Precursor Membrane has at least one surface made of a poly(aryl ether ketone) polymer. The step of chemically treating the Precursor Membrane provides the membrane with at least one surface comprising hydroxyl groups bound to aromatic rings in the poly(aryl ether ketone) polymer backbone. In other words, the step of chemically treating the Precursor Membrane provides the membrane with at least one surface comprising a functionalized poly(aryl ether ketone) polymer as defined above. The hydroxyl groups are generally directly bound to the carbon atoms of the aromatic rings.

In a first step, the process comprises providing a Precursor Membrane comprising a poly(aryl ether ketone) polymer and having a contact angle measured according to the captive bubble contact angle test of less than 155° and/or a static contact angle that does not decrease over time.

Precursor Membrane may be prepared according to any method known in the art for the preparation of porous membranes comprising poly(aryl ether ketone) polymers.

Suitable methods for preparing porous membranes by processing poly(aryl ether ketone) polymers are for instance those described in U.S. Pat. Nos. 4,957,817, 5,200,078, 5,205,968 and 4,755,540.

More advantageously, Precursor Membrane may be prepared according to any method described in WO2018065526A1, WO2021018868A1 or WO2022096373A1.

In a first embodiment Precursor Membrane is prepared according to a method comprising:
(i) processing a polymer composition comprising a poly(aryl ether ketone) polymer and at least 28 wt. %, based on the total weight of the polymer composition, of at least one additive of formula (I):

Rₐ—Ar—X_{b} (I)
where: Ar is selected from the group consisting of substituted or unsubstituted, monocyclic or polycyclic aromatic group having 5 to 18 carbon atoms, each of R, identical or different from each other, is selected from the group consisting of a halogen, an hydroxyl, a C1-C18 aliphatic group, a C1-C18 cycloaliphatic group and a C1-C18 aromatic group; a is zero or an integer ranging from 1 to 5; X is (SO₃⁻), (M^{p+})_{1/p} or (COO⁻), (M^{p+})_{1/p} in which M^{p+} is a metal cation of p valence; and b is an integer from 1 to 4 into a solid article, and
(ii) immersing the solid article into water to obtain a porous article.

The additive of formula (I) is preferably selected from the group consisting of an alkali metal salt of benzoate, methylbenzoate, ethylbenzoate, propylbenzoate, benzene sulfonate, benzene disulfonate, p-toluene sulfonate, xylene sulfonate, cumene sulfonate, p-cymene sulfonate and dodecylbenzene sulfonate.

In a preferred embodiment Precursor Membrane is prepared according to a method comprising:
(I) providing a composition comprising at least one poly(aryl ether ketone) polymer, at least one poly(aryl ether sulfone) polymer, and at least one compound comprising a sulfonate or carboxylate salt of a metal selected from the group consisting of alkaline metals, alkaline-earth metals, aluminum, iron, zinc, nickel, copper, palladium and silver;
(II) processing said composition to provide pellets;
(III) melt extruding the pellets obtained in step (II), thus providing a precursor layer;
(IV) contacting said precursor layer with at least one organic solvent or with water and subsequently with at least one organic solvent, thus providing an intermediate porous layer;
(V) contacting said intermediate porous layer obtained in step (IV) with water, thus providing a porous membrane.

The poly(aryl ether sulfone) polymer is preferably selected from polyphenylsulfone (PPSU), polyethersulfone (PES) or polysulfone (PSU).

The compound comprising a sulfonate or a carboxylate salt is selected from the benzoate, methylbenzoate, ethylbenzoate, propylbenzoate, benzene sulfonate, benzene disulfonate, p-toluene sulfonate, xylene sulfonate, cumene sulfonate, p-cymene sulfonate and dodecylbenzene sulfonate salts. Preferably it is selected from the group consisting of: sodium or potassium benzoate, sodium or potassium methyl benzoate, sodium or potassium ethylbenzoate, sodium or potassium butylbenzoate, sodium or potassium benzene sulfonate, sodium or potassium benzene-1,3-disulfonate, sodium or potassium p-toluene sulfonate, sodium or potassium xylenesulfonate, sodium or potassium cumene sulfonate, sodium or potassium para-cymene sulfonate, sodium or potassium n-butyl benzene sulfonate, sodium or potassium iso-butyl benzene sulfonate, sodium or potassium tert-butyl benezene sulfonate and sodium or potassium dodecylbenzenesulfonate.

In a second step the process for the preparation of the inventive membrane comprises a chemical treatment of Precursor Membrane to obtain a contact angle measured according to the captive bubble contact angle test of at least 155° and/or a static contact angle that decreases over time.

The chemical treatment provides the membrane with at least one surface comprising hydroxyl groups bound to aromatic rings in the poly(aryl ether ketone) polymer backbone, that is at least one surface comprising a functionalized poly(aryl ether ketone) polymer.

The chemical treatment comprises contacting Precursor Membrane with a peroxide in the presence of an oxidation catalyst comprising iron (II) or iron (III) ions to obtain to provide hydroxyl groups bound to the aromatic rings of the poly(aryl ether ketone) polymer backbone. Hydroxyl groups are bound to the aromatic rings of the poly(aryl ether ketone) polymer backbone at least on a surface of the membrane.

The chemical treatment is typically performed in an aqueous medium. The chemical treatment may be conveniently performed by dipping or immersing the Precursor Membrane in a bath or tank containing an aqueous solution containing the oxidation catalyst and the peroxide.

The peroxide is typically hydrogen peroxide. The concentration of hydrogen peroxide in the aqueous medium is typically from 0.5 to 15.0 wt % with respect to the aqueous medium, even from 1.0 to 10.0 wt %.

The oxidation catalyst is preferably in the form of a salt. A notable example of a suitable salt is Fe(NH₄)₂(SO₄)₂*6H₂O. The concentration of iron (II) or iron (III) ions in the aqueous medium is not limiting. It is typically at least 1.0×10⁻⁴ M in the aqueous medium.

The treatment is typically performed under acidic conditions; preferably at a pH of the aqueous medium of less than 6.0, more preferably at a pH of 3.0 to 5.0.

The treatment is typically performed at a temperature 30° C. to 95° C., preferably from 40° C. to 90° C.

If the Precursor Membrane is dipped, it may remain in the aqueous medium for a period of time from one second to 10 hours, generally from 5 to 60 minutes.

The process may additionally comprise a step of washing the membrane followed by drying.

The inventive membrane, because of the inherent chemical stability of poly(aryl ether ketone) polymers, combined with the increased hydrophilicity is particularly adapted for use as separator in alkaline water electrolysis device.

An alkaline water electrolysis device comprises an anode, a cathode, and a porous membrane as above detailed, the membrane being placed between the anode and cathode. In a more specific example, the interior of the alkaline water electrolysis device is divided by the porous membrane of the invention into an anode compartment, comprising the anode, and a cathode compartment, comprising the cathode, and wherein oxygen gas and hydrogen gas evolved from the electrodes are kept from being mixed.

The configuration of the alkaline water electrolysis device of the present invention is not particularly limited, as long as it includes the inventive membrane. The membrane of the invention, when used as separator in an alkaline water electrolysis device, is typically in the form of a flat membrane. It is advantageously in the form of a flat membrane comprising a porous substrate. Advantageously a porous substrate which is in the form of a mesh, preferably a poly(phenylene sulfide) mesh.

The membrane when used as separator in an alkaline water electrolysis device is characterized by a contact angle measured according to captive bubble contact angle test of at least 155°, even at least 157° and/or by a static contact angle that decreases over time, preferably a static contact angle which when measured after 60 seconds decreases of 15° with respect to the initial value.

The method and conditions for electrolysis using the alkaline water electrolysis device of the present invention are not particularly limited, and known methods and conditions can be employed. For example, the interior of the alkaline water electrolysis device is filled with an alkaline solution, and a direct current is applied between the anode and the cathode. For example, an aqueous solution of sodium hydroxide or potassium hydroxide is used as the electrolyte solution.

Hydrogen can be industrially produced by water electrolysis process which uses the alkaline water electrolysis device of the present invention and in which a variable power supply is applied to the device. That is, the method for producing hydrogen according to the present embodiment includes the step of electrolyzing alkaline water by applying a voltage to the alkaline water electrolysis device according to the present embodiment using a variable power supply. With the method for producing hydrogen according to the present embodiment, a variable power supply derived from a renewable energy source such as a large-scale wind-power generation or photovoltaic generation can be efficiently and stably converted to and stored as hydrogen.

Thus, an exemplary beneficial use of an electrolytic cell incorporating the membrane of the present invention is to allow electricity derived from renewable energy sources to be converted to and stored as hydrogen.

The porous membrane of the invention may conveniently be used also in filtration devices, such as microfiltration or ultrafiltration devices.

An object of the invention is thus also a method for filtering at least one fluid, said method comprising contacting said fluid with at least one porous membrane of the invention. The at least one fluid is a gas or a liquid and is preferably selected from the group consisting of biologic solution, buffer solutions, oil/water emulsions, water, hydrocarbons. Among oil/water emulsions notable examples are fracking water and the so-called “produced water”, or in another words water coming from oil wells, water with high solid content, waste water.

Hereinafter, the present invention will be described in more detail with reference to examples and comparative examples.

The embodiments above are intended to be illustrative and not limiting.

Additional embodiments are within the inventive concepts. In addition, although the present invention is described with reference to particular embodiments, those skilled in the art will recognized that changes can be made in form and detail without departing from the spirit and scope of the invention.

### EXAMPLES

### Materials

The following were obtained from Solvay Specialty Polymers USA, LLC.:
PEEK: Ketaspire® KT-820 NL PEEK polymer (MFR measured @400° C. and 2.16 Kg=3 g/10 min);
PSU: Udel® P1700 PSU polymer (MFR measured @343° C./2.16 Kg=6.5 g/10 min);
Dimethyl sulfoxide (DMSO) and isopropyl alcohol (IPA) were obtained from Sigma Aldrich®.
Micronized Sodium Benzoate was commercially available from Fluid Energy, Telford, PA.

### Bubble Point and Pore Size Determination

Membranes bubble points (i.e, the measure of the largest pores), smallest pore size and average pore size were determined following ASTM F316 method, using a capillary flow porometer Porolux™ 1000 (Porometer-Belgium).

For each test, membrane samples were initially fully wetted using Fluorinert C 43 (fluorinated fluid with a surface tension of 16 dyn/cm).

Nitrogen (inert gas) was used.

### Measurement of Static Contact Angle (CA)

Static water contact angles were evaluated at 25° C. by using a DSA10 equipment (Krüss GmbH, Germany), according to ASTM D 5725-99. Contact angle was measured on only one side of the flat membranes. Results shown in Table 2 are an average of at least 10 drops of water. Volume of drops was 2 μL. The contact angle was measured immediately after deposition of the water droplet and re-measured on the same sample after the time shown in Table 2 under the same experimental conditions.

### Captive Air Bubble (CAB) Method

This method measures the contact angle of an air bubble at a surface immersed in a liquid, in this case water. As the determination is performed on membranes which are already wet, swelling and water absorption are suppressed. The instrument lay out used for the determination is described in WO 2021/12262S A1 (page 40 and FIG. I). Air Contact Angle (ACA) measurements were carried out at room temperature, using an adapted environment controlled chamber filled with deionized water (I) (DI water). Prior to analysis, the wet samples were supported on a 15×5 mm glass substrate, fixed on a sample holder with double-sided tape. Samples were then immersed in DI water, and a 2 μL air bubble was dropped on the sample surface using a J-shaped syringe. Contact Angle measurements were performed using an optical tensiometer (Attension Theta Flex provided by BIOLIN) equipped with a high quality monochromatic cold LED light and a high resolution (1984×1264) digital camera. Image acquisition parameters were set at 5 Frames Per Second (FPS) and a minimum acquisition time of 60 s. The instrument was calibrated using a calibration ball (CA=143.15′) with an accepted error of 0.03. Obtained contact angle values are the average of 5 measurements performed on the same sample.

### Preparation of Precursor Membrane (PQ)

PEEK and sodium benzoate were blended using a ZSK-26 twin screw extruder (Coperion GmbH, Stuttgart, Germany), equipped with 12 barrel zones and a heated exit die operating at up to 450° C.

The barrel profile was as follows:

| Barrel# | 1 | 2 | 3 | 4 | 5 | 6 | 7 | 8 | 9 | 10 | 11 | 12 | Die |
|---|---|---|---|---|---|---|---|---|---|---|---|---|---|
| Set Point | — | 330 | 330 | 360 | 360 | 360 | 360 | 360 | 340 | 340 | 340 | 340 | 360 |
| (°C) | | | | | | | | | | | | | |

A K-TronT-35 gravimetric feeder (from Coperion GmbH, Stuttgart, Germany) was used to feed the pre-blend into the feeding section(s) of the extruder to yield the proper mass ratio of the components.

The components were melted and mixed with screws designed to achieve a homogeneous melt composition. The actual melt temperature at the exit die was measured with a hand-held device and found to be between 390-400° C.

The melt stream was air cooled and fed into a Maag Primo 60E pelletizer (from Maag Automatik GmbH, Stuttgart, Germany). Pellets were collected and used to make a compound comprising (all amounts are expresses as wt % with respect to the total weight of the composition):
PEEK: 40.6 wt %
PSU: 38.5 wt %
Sodium Benzoate: 20.9 wt %.

The pellets were collected and kept in sealed plastic buckets until used for melt film extrusion. The pellets were dried overnight at 130° C. and subsequently fed to a single screw extruder and extruded into a film with a profile temperature of 360-390° C. using a film die. The film was taken up on a chilled godet roll operating at speed from 0.5 to 2 m/min and temperature from 90 to 170° C.

The precursor layer obtained in the above step was leached in DMSO at 120° C. overnight, allowed to settle and fresh DMSO was added with agitation for 2 hours. The washing was repeated by adding clean DMSO with agitation for 2 hours at room temperature, then transitioned to water with 3 water washes with agitation for 1 hour each.

### Examples: Preparation and Testing of Membranes 1 to 3

Samples of the Precursor Membrane obtained in the previous step were pre-wetted in alcohol and were then dipped in a Pyrex® glass pan containing 0.8 L of an aqueous solution containing hydrogen peroxide and Fe(NH₄)₂(SO₄)₂*6H₂O (9.1×10⁻⁴ M). The pH of the solution was set at 4.0 by adding H₂SO₄ 0.05M. The temperature was set at 75° C. and the reaction was allowed to proceed for 30 minutes. Different concentrations of hydrogen peroxide were used. The results are summarised in Table 1.

TABLE 1

| | H₂O₂ | Bubble point | Average pore | Smallest pore |
|---|---|---|---|---|
| Sample | (wt %) | (nm) | diameter (nm) | diameter (nm) |
| Precursor | — | 144 | 96 | 77 |
| Membrane | | | | |
| Membrane 1 | 1.0 | 172 | 107 | 73 |
| Membrane 2 | 2.5 | Not | Not | Not |
| | | measured | measured | measured |
| Membrane 3 | 5.0 | 201 | 111 | 71 |

The static contact angle, its evolution in time as well as the captive air bubble contact angle were determined. They are summarized in Table 2.

TABLE 2

| | | Static | Static | Static | Captive |
|---|---|---|---|---|---|
| | | contact | contact | contact | Air |
| | H₂O₂ | angle (°) | angle (°) | angle (°) | Bubble |
| Sample | (wt %) | at t = 0 s | at t = 30 s | at t = 120 s | (°) |
| Precursor | — | 101 | 101 | 101 | 152 |
| Membrane | | | | | |
| Membrane 1 | 1.0 | 87 | Not | 53 | 157 |
| | | | measured | | |
| Membrane 2 | 2.5 | Not | Not | Not | 165 |
| | | measured | measured | measured | |
| Membrane 3 | 5.0 | 66 | 0 | 0 | * |

* Not possible to measure: the air droplet does not stick on the surface of the membrane.

The contact angle results in Table 2 show the increased hydrophilicity of the Membranes 1 to 3. A higher hydrogen peroxide concentration during the membrane preparation process leads to higher hydrophilic character of the membranes.

Membrane 3 shows the highest hydrophilic character: in the case of the static contact angle the water drop is adsorbed in less than 30 seconds. In the captive air bubble test the air bubble cannot even be deposited on the surface of the membrane due to its hydrophilicity. This is a particularly advantageous result as this measurement mimics the real conditions of the use of a membrane in an alkaline electrolyser.

### Determination of the Presence of Hydroxyl Groups in Membrane 3

A sample (4×4 cm² surface) of Membrane 3 was treated with a solution of trifluoroacetic anhydride (4 ml) in diethyl ether (60 ml) overnight, rinsed with acetonitrile twice then dried at 40° C. under vacuum.

The sample thus obtained, in form of thin sheet, was characterized through solid-state NMR spectroscopy. ¹⁹F MAS NMR spectra were recorded on an Agilent DD2 400 MHz NB spectrometer using a 1.6 mm T3 MAS special HFXY probe at room temperature. ¹⁹F one pulse spectra were acquired at a spinning speed of 34 kHz, using a 90° pulse of 4.2 μs, a recycle delay of 20 s and 304 scans. 19F chemical shifts δCS are reported relative to CFCl3, using PTFE (δCS=−123 ppm) as secondary standard.

The spectrum obtained for Membrane 3 after treatment with trifluoroacetic anhydride showed a contribution at −75 ppm which is clearly observable and which was not present in the NMR spectrum of Membrane 3. The peak at −75 ppm is assigned to the presence of —CF₃ groups deriving from the conversion of the —OH groups in the sample to —CF₃ groups through trifluoroacetylation.

### Measure the Through-Plane Conductivity of Membranes in Alkaline Electrolyte Using the H-Cell System.

The determination of the membrane conductivity is based on the measurement of the slope of the cell polarization curve, carried out with a voltage sweep, in the voltage (V) towards current (I) graph; the slope representing the resistance of the cell. The Areal Surface Resistance (ASR) for each membrane was obtained subtracting the cell resistance without the membrane from the resistance with the membrane, and multiplying the value with the free area of the sample.

The cell consists of two glass compartments separated by the membrane (or a single compartment if mounted without a membrane). In each compartment there is a working electrode consisting of a platinum spiral filament and an Ag/AgCl reference electrode. The reference electrodes are inserted in glass tubes (Luggin capillaries) whose ends are placed near the membrane; the voltage on the reference electrode is linked to the voltage of the electrolyte near the tip of the glass tube. The measured resistance of the cell is therefore a function of the distance between the two capillaries.

The ASR data are reported in Table 3. All Membranes 1 to 3 had a thickness of 310 microns.

TABLE 3

| | | Membrane 1 | Membrane 2 | Membrane 3 |
|---|---|---|---|---|
| | | ASR | ASR | ASR |
| solution | T (C°) | (ohm*cm²) | (ohm*cm²) | (ohm*cm²) |
| KOH 10% | 30 | 0.0021 | 0.0022 | 0.0021 |
| KOH 10% | 60 | 0.0015 | 0.0016 | 0.0015 |

The data show that the inventive membranes have good ion conductivity values.

1. A porous membrane comprising at least one poly(aryl ether ketone) polymer, said membrane having a contact angle measured according to the captive bubble contact angle test of at least 155° and/or a static contact angle measured according to ASTM D 5725-99 that decreases over time, and wherein said membrane comprises at least one surface comprising at least one functionalized poly(aryl ether ketone) polymer which comprises hydroxyl groups bound to aromatic rings of a poly(aryl ether ketone) polymer backbone.

2. The membrane of claim 1 wherein the poly(aryl ether ketone) polymer comprises at least 50 mol % of recurring units (R_{PAEK}) selected from the group consisting of formulae (J-A) to (J-O): 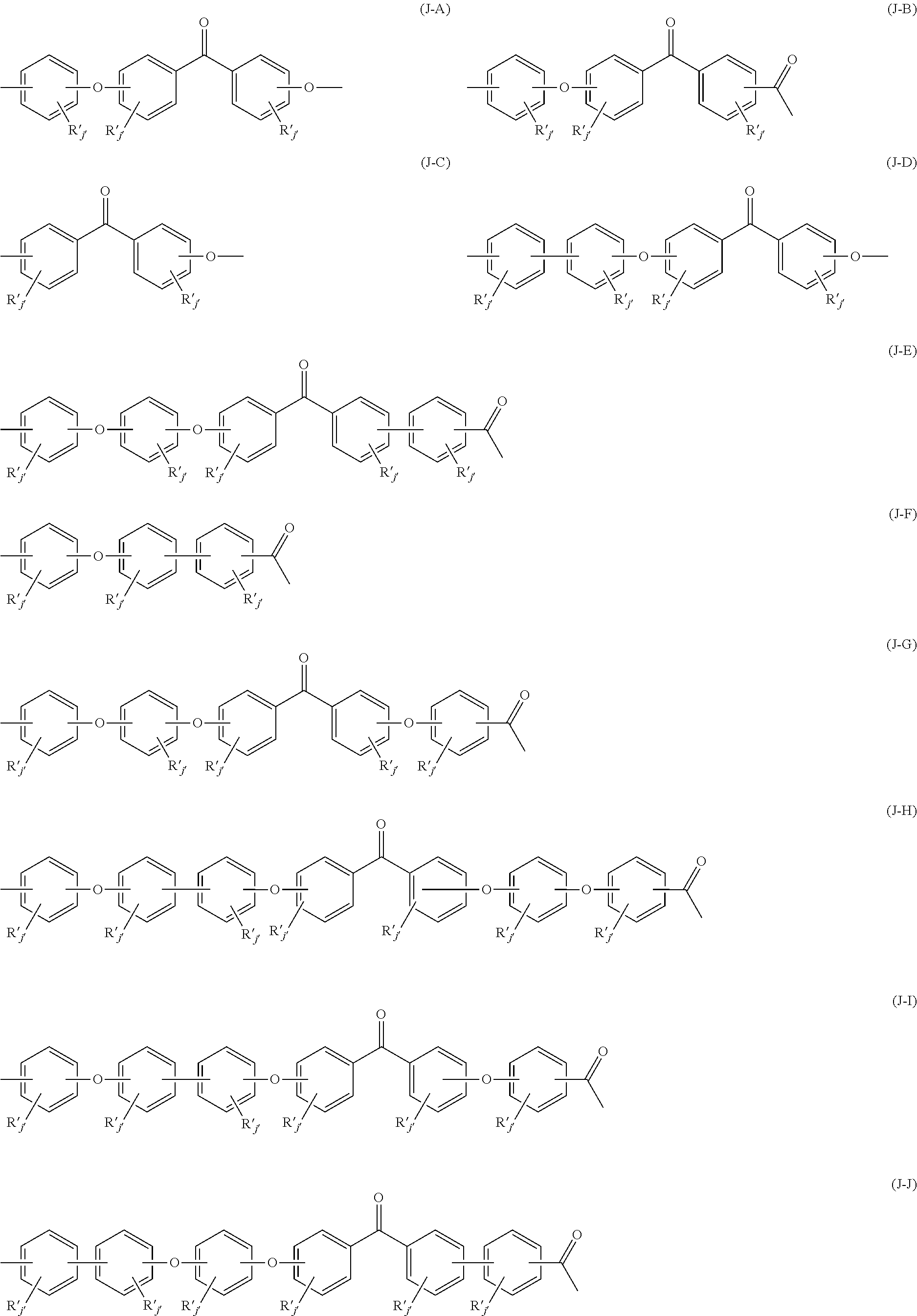 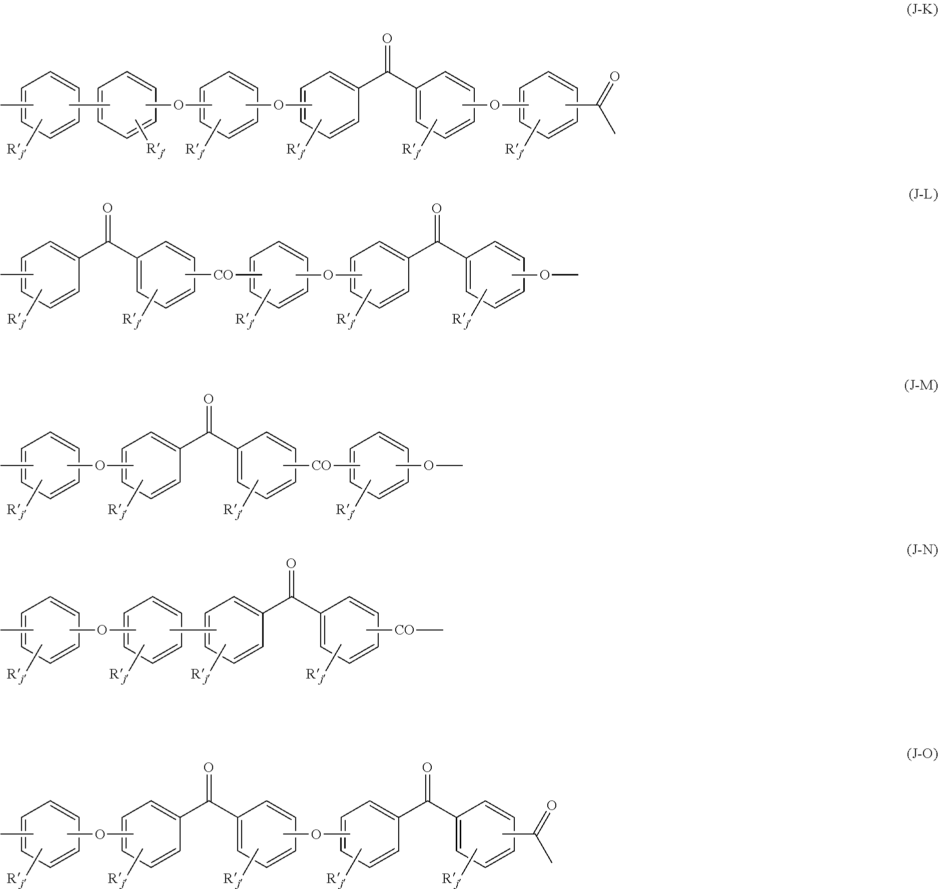
where:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 1 to 4.

3. The membrane of claim 2 wherein recurring units (R_{PAEK}) are selected from the group consisting of units of formulae (J′-A) to (J′-D) and (J″-B):

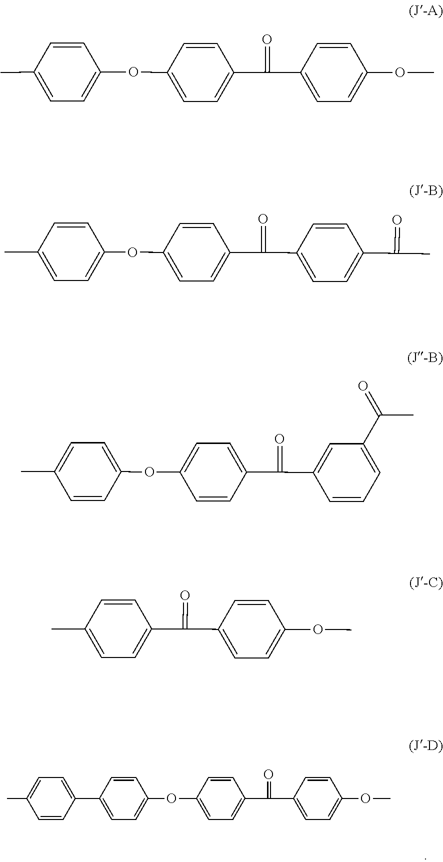

4. The membrane of claim 1 wherein the functionalized poly(aryl ether ketone) polymer comprises recurring units (R_{PAEK-OH}) which are selected from the group consisting of units of formulae (K-A) to (K-D): 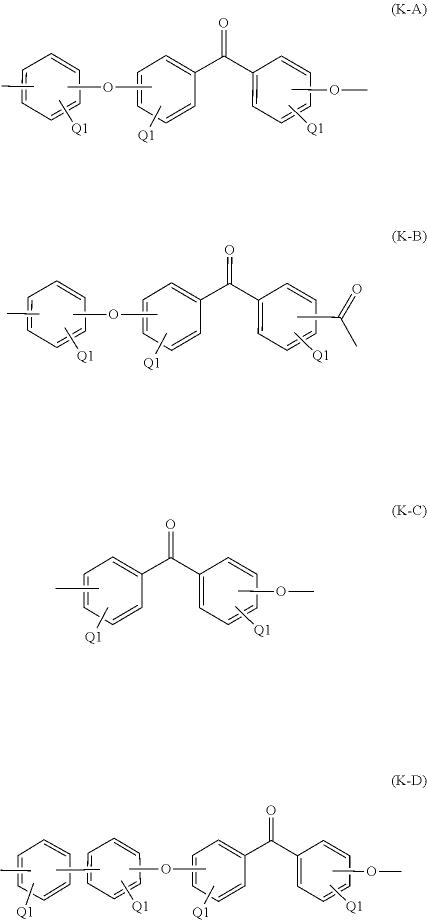
in which each of Q′ is —OH and, independently at each instance, i is zero or an integer from 1 to 4, with the proviso that in the recurring unit the total sum of all i is different from zero.

5. The membrane of claim 4 wherein the functionalized poly(aryl ether ketone) polymer further comprises recurring units (R_{PAEK}) which are selected from the group consisting of units of formulae (J′-A) to (J′-D) and (J″-B):

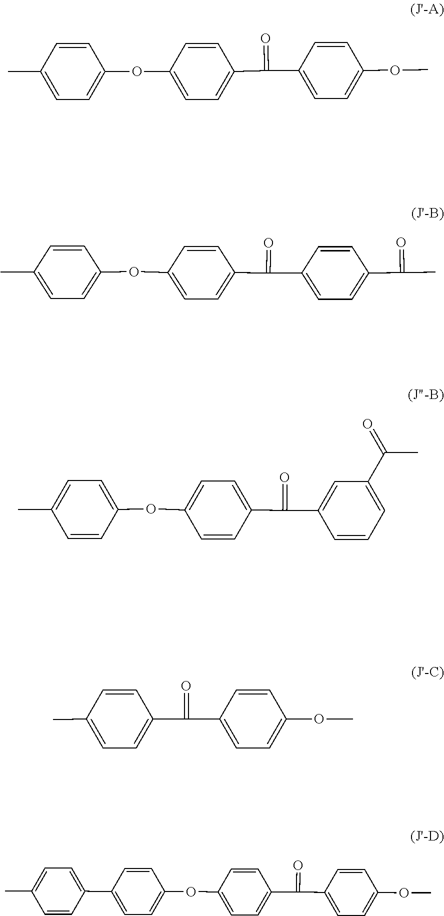

6. The membrane of claim 1 wherein the functionalized poly(aryl ether ketone) polymer includes a combined amount of recurring unit (R_{PAEK-OH}) and recurring unit (R_{PAEK}) of at least 50 mol %, relative to the total number of recurring units in the functionalized poly(aryl ether ketone) polymer.

7. The membrane of claim 1 wherein the functionalized poly(aryl ether ketone) polymer comprises 0.001 mol % or more of recurring units (R_{PAEK-OH}) relative to the number of recurring units in the functionalized poly(aryl ether ketone) polymer.

8. The membrane of claim 1 wherein the functionalized poly(aryl ether ketone) polymer comprises at least 60 mol % of recurring units which are a combination of recurring units of formula (K-A) and (J′-A): 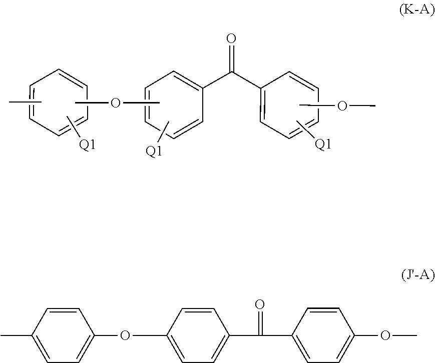
with the proviso that the amount of recurring units (K-A) is different from zero.

9. The membrane of claim 1 wherein the functionalized poly(aryl polymer comprises at least 60 mol % of recurring units which are a combination of recurring units of formula (K-A) and/or (J′-A) and recurring units of formula (K-D) and/or (J′-D): 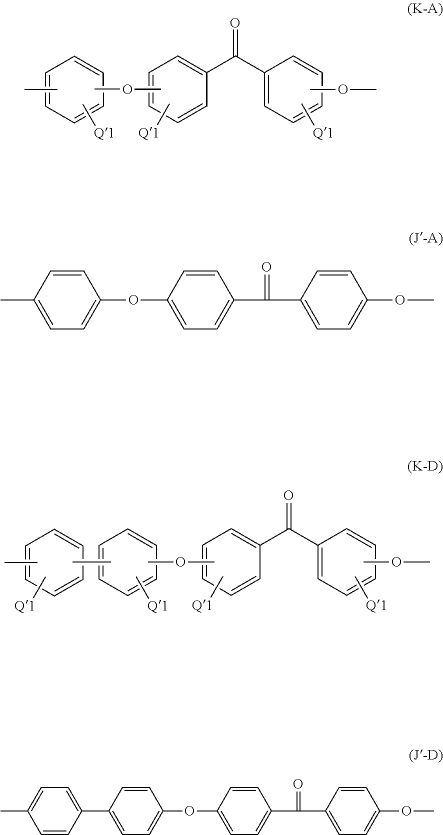
with the proviso that the amount of recurring units (K-A)+(K-D) is different from zero.

10. A process for making a membrane of claim 1 comprising:
providing a precursor membrane which is a membrane comprising a poly(aryl ether ketone) polymer having a contact angle measured according to the captive bubble contact angle test of less than 1550 and/or a static contact angle that does not decrease over time; and
chemically treating the precursor membrane to provide the membrane with at least one surface comprising hydroxyl groups bound to aromatic rings in the poly(aryl ether ketone) polymer backbone and to obtain a contact angle, measured according to the captive bubble contact angle test, of at least 155° and/or a static contact angle that decreases over time.

11. The process of claim 10 wherein the precursor membrane comprises at least one surface comprising a poly(aryl ether ketone) polymer.

12. The process of claim 10 in which the step of chemically treating the precursor membrane comprises contacting the precursor membrane with a peroxide in the presence of an oxidation catalyst comprising iron (II) or iron (III) ions to obtain hydroxyl groups bound to aromatic rings of the poly(aryl ether ketone) polymer backbone in the precursor membrane.

13. The process of claim 10 in which the step of providing the precursor membrane comprises the following steps:
(I) providing a composition comprising at least one poly(aryl ether ketone) polymer, at least one poly(aryl ether sulfone) polymer, and at least one compound comprising a sulfonate or carboxylate salt of a metal selected from the group consisting of alkaline metals, alkaline-earth metals, aluminum, iron, zinc, nickel, copper, palladium and silver;
(II) processing said composition to provide pellets;
(III) melt extruding the pellets obtained in step (II), thus providing a precursor layer;
(IV) contacting said precursor layer with at least one organic solvent or with water and subsequently with at least one organic solvent, thus providing an intermediate porous layer;
(V) contacting said intermediate porous layer obtained in step (IV) with water, thus providing a porous membrane.

14. An alkaline water electrolysis device comprising:
an anode;
a cathode; and
the membrane of claim 1, the membrane being placed between the anode and the cathode.

15. A method for producing hydrogen, comprising the step of electrolyzing alkaline water by applying a voltage to the alkaline water electrolysis device according to claim 14.

16. A method for filtering at least one fluid, said method comprising contacting said fluid with at least one membrane of claim 1 wherein said at least one fluid is a gas or a liquid.

17. The membrane of claim 1, wherein the static contact angle is at least 150 lower with respect to the initial value, when measured after 60 seconds.

18. The membrane of claim 8, wherein the functionalized poly(aryl ether ketone) polymer comprises at least 70 mol % of recurring units which are a combination of recurring units of formula (K-A) and (J′-A).

19. The membrane of claim 9, wherein the functionalized poly(aryl polymer comprises at least 70 mol % of recurring units which are a combination of recurring units of formula (K-A) and/or (J′-A) and recurring units of formula (K-D) and/or (J′-D).

20. The method of claim 16, wherein the at least one fluid is selected from the group consisting of biologic solution, buffer solutions, oil/water emulsions, water, and hydrocarbons.
